(19) United States
(12) Patent Application Publication
(10) Pub. No.: US 2002/0041692 A1
(43) Pub. Date: Apr. 11, 2002

(54) Audio system and method of providing music

(75) Inventors: Fumio Seto, Kanagawa-ken (JP); Tatsumi Yanai, Kanagawa-ken (JP)

Correspondence Address: McDERMOTT, WILL & EMERY, 600 13th Street, N.W., Washington, DC, 20005-3096, US

(73) Assignee: Nissan Motor Co., Ltd.

(21) Appl. No.: 09/970,886

(22) Filed: Oct. 5, 2001

(30) Foreign Application Priority Data
Oct. 10, 2000 (JP) P2000-309242

(51) Int. Cl. H04B 1/00

(52) U.S. Cl. 381/86; 700/94

(57) ABSTRACT

An audio system and a method providing music, matched to driver's favorite, to the vehicle driver. Music related information is inputted into an information storage section, and favorite information with respect music is detected by a favorite information detecting section. The detected favorite information is analyzed by a favorite analysis section, and analyzed resultant data is stored in the information storage section. A music title, which is matched to the driver's favorite, is selected on the basis of the analyzed resultant data by a music selecting section, and is provided to the vehicle driver through a music providing section.

### BACKGROUND OF THE INVENTION

The present invention relates to an audio system and a method providing music to a driver and, more particularly, to an audio system and a method providing a favorite piece of music to the driver during his driving operation.

In order to have a driver to nicely drive a vehicle, music, to which the driver listen, should be preferred to be matched to the driver's favorite.

In recent years, it has been proposed to provide an awakening condition sustainer device that detects the driver's physiological signal and variations in driving status of the vehicle for discriminating whether or not the driver is driving the vehicle in a monotonous manner, i.e., whether or not the driver is maintained in an awakening state, to enable the driver to be applied with an acoustic stimulation for sustaining driver's awakening state by varying the sound of music when a discriminated resultant value exceeds a predefined threshold level, a structure of which is disclosed in Japanese Patent Application Laid-Open Publication No. 8-188123.

In such an awakening condition sustainer device, it has been a usual practice to execute discrimination whether or not the driver remains in the physiologically awakening state, and there has been no approach to find out the driver's favorite with respect to a particular piece of music from the driver's characteristic to take it into consideration.

### SUMMARY OF THE INVENTION

In such an awakening condition sustainer device, however, since the acoustic stimulation with music is applied to the driver with a view to sustaining the driver's awakening condition, the driver is apt to be left in an uncomfortable environment during his driving operation. As such, although it is originally quite natural for the driver to enjoy driving the vehicle, the driver suffers pains during driving the vehicle.

When listening to music during driving the vehicle, driving the vehicle while listening to a particular favorite piece of music renders the driver to feel in a happy frame of mind, whereas driving the vehicle while listening to a particular unfavorable piece of music renders the driver to feel in an unhappy frame of mind. Especially when the driver is exhausted, he wants to drive the vehicle while listening to only the music pieces of a favorite artist. However, in an album of the particular artist, it happens that the album contains a repugnant music piece (i.e., which makes the driver to feel unhappy during driving operation). Furthermore, in a radio broadcasting where the driver is forced to passively hear the unfavorable music pieces, it is hardly to expect for only the favorable music pieces to be provided at all times.

The present invention has been made in view of the above studies and has an object to provide an audio system and a method of providing a favorite piece of music to a vehicle driver during his driving operation.

According to one aspect of the present invention, there is provided an audio system providing a favorite piece of music to a vehicle driver during a driving operation of the vehicle driver, which comprises: an input section to which music-related information is inputted; an information storage section storing the music-related information inputted to the input section; a favorite information detecting section detecting favorite information to discriminate favorite tendency of the vehicle driver with respect to the favorite piece of music; a favorite analysis section analyzing a favorite of the vehicle driver on the basis of the detected favorite information and transferring analyzed resultant data to the information storage section to be stored thereby; a music selecting section selecting the favorite music piece on the basis of the analyzed resultant data; and a music providing section providing the selected favorite music piece to the vehicle driver.

In other word, an audio system of the present invention comprises: inputting means for inputting music-related information; information storing means for storing the music-related information; favorite information detecting means for detecting favorite information to discriminate favorite tendency of the vehicle driver with respect to the favorite piece of music; favorite analyzing means for analyzing a favorite of the vehicle driver on the basis of the detected favorite information and transferring analyzed resultant data to the information storage means to be stored thereby; music selecting means for selecting the favorite music piece on the basis of the analyzed resultant data; and music providing means for providing the selected favorite music piece to the vehicle driver.

Besides, in the present invention, a method, which is for providing a favorite piece of music to a vehicle driver during a driving operation of the vehicle driver, detects favorite information to discriminate favorite tendency of the vehicle driver with respect to the favorite piece of music, analyzes driver's favorite on the basis of the detected favorite information and storing analyzed resultant data, selects the favorite music piece on the basis of the analyzed resultant data, and provides the selected favorite music piece to the vehicle driver.

Other and further features, advantages, and benefits of the present invention will become more apparent from the following description taken in conjunction with the following drawings.

### BRIEF DESCRIPTION OF THE DRAWINGS

FIG. 1 is a block diagram of an audio system of a first embodiment according to the present invention;

FIG. 2 is a table illustrating the relationship between a favorite rank and a favorite parameter of the embodiment;

FIG. 3 is a table illustrating the relationship between music pieces and a vehicle's information of the embodiment;

FIG. 4 is a table illustrating the relationship between music pieces and a consciousness information of the embodiment;

FIG. 5 is a table illustrating the relationship between music pieces and a vehicle's traveling information of the embodiment;

FIG. 6 is a table illustrating the relationship between music pieces and driver's will information of the embodiment;

FIG. 7 is a table illustrating an example of a conversion process to be carried out in a favorite converting unit shown in FIG. 1;

FIG. 8 is a view of an example illustrating a music-piece selection table indicating music pieces correlated with graded favorite degrees;

FIG. 9 is a general flow diagram for illustrating the basic sequence of operations of the audio system shown in FIG. 1;

FIG. 10 is a block diagram of an audio system of a second embodiment according to the present invention; and

FIG. 11 is a flow diagram for illustrating the basic sequence of operations of the audio system shown in FIG. 10.

### DETAILED DESCRIPTION OF THE PREFERRED EMBODIMENTS

To describe the present invention more in detail, several embodiments of the present invention will be explained with reference to the accompanied drawings below.

### First Embodiment

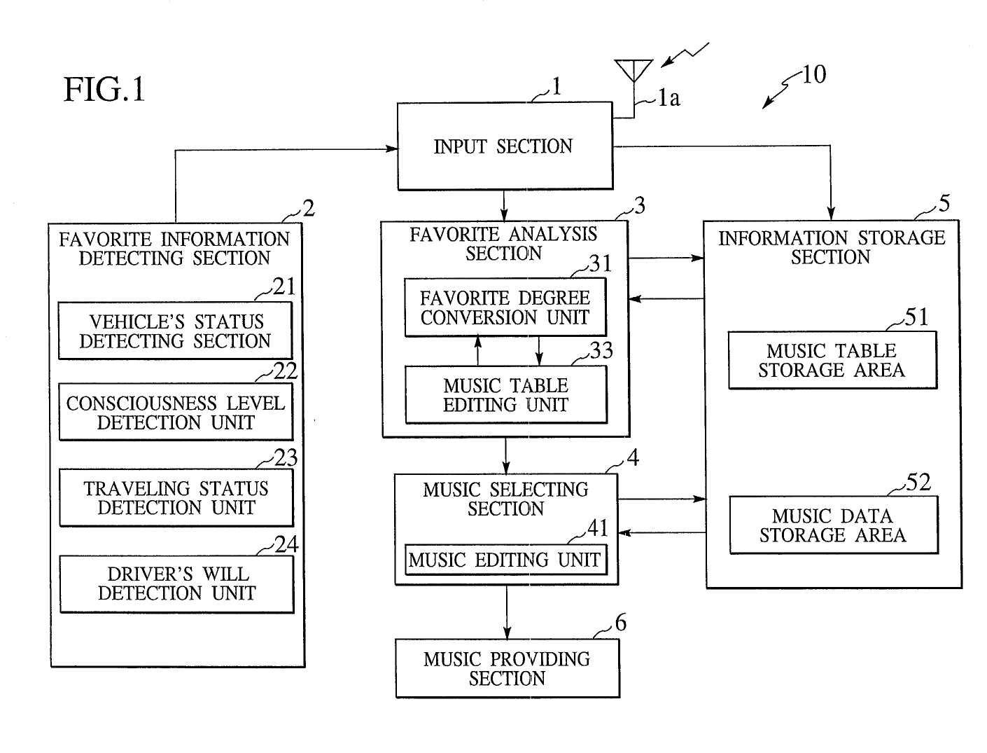

Referring to FIG. 1, there is shown a block diagram of a first embodiment of an audio system according to the present invention to carry out a method for providing a favorite piece of music to a vehicle's driver.

### Hardware Overview

The audio device 10 includes an input section 1 which has an antenna 1a to receive music-related information, etc., a favorite information detecting section 2 which detects a particular vehicle-driver's favorite tendency with respect to favorite pieces of music for thereby producing favorite information signal, a favorite analysis section 3 which analyzes a vehicle-driver's favorite with respect to music pieces on the basis of the favorite information signal delivered from the favorite information detecting section 2 to produce an analyzed signal related to the favorite music pieces, a music-piece selecting section 4 responsive to the analyzed signal for selecting the favorite piece of music, an information storage section 5 which stores music-related information that is received or that is input, and a music providing section 6 which provides the favorite piece of music, selected by the music piece selecting section 4, to the vehicle driver.

### Input Section

The input section 1 receives an input data signal identifying the particular vehicle driver, music-related data signal, and several command signals such as a music selection command signal and an end signal by the vehicle driver, etc. Such a data signal may be preliminarily preset and stored in the information storage section 5 or may be inputted in a radio connection through a network such as the Internet on a real time basis.

### Information Storage Section

The information storage section 5 has a music selection table storage area 51 and a music data storage area 52. The music selection table contains a plurality of music-pieces under respective music titles correlated with respective favorite degrees, which are graded, as will be described below in detail.

The music data includes information which has contents of the music pieces. The music data storage area 52 may take any form of media, containing stored data, such as a CD-ROM, MD, MO, floppy disk, flexible disk, magnetic tape, any other magnetic medium and any other optical medium, etc., a readout unit for reading out stored data, a hard disk which is recorded with plural music pieces, or other record medium (i.e., storage area) of a server which can be accessed through a disconnected network, such as the Internet. The music data storage area 52 is meant not only by the hard disk incorporated in the audio system of the present invention, but also by whole record media which can be currently recorded with music data.

### Favorite Detecting Section

The favorite detecting section 2 serves to detect the favorite tendency peculiar to the particular vehicle driver to produce the favorite information signal. In order to properly grasp the favorite tendency of the vehicle driver, in such an embodiment, the favorite tendency detecting section 2 is constructed of a vehicle's status detecting unit 21 which detects vehicle's information, a consciousness level detecting unit 22 which detects a consciousness level of the vehicle driver, a traveling status detecting unit 23 which detects traveling information of the vehicle, and a driver's will detecting unit 24 which detects will information of the driver.

These detecting units serve as respective suitable detection means for obtaining respective information, with detected resultant data being stored in the information storage section 5. For example, the vehicle's status detecting unit 21 may be arranged to detect (i.e., to receive) information through a car navigation system in terms of a particular vehicle's information such as a vehicular location.

The consciousness level detecting unit 22 includes measuring instruments for measuring the driver's heart rate or brain waves using driver's arm, ear or neck etc. to obtain driver's consciousness information.

The traveling status detecting unit 23 may be electrically connected to a vehicle's traveling status management device such as a vehicular speed control system and a steering control system, for the manipulation of a steering wheel, etc. for obtaining information indicative of the vehicle's traveling status.

The driver's will detecting unit 24 includes an action detection unit which is arranged to detect the driver's action based on his will for obtaining will information from the driver. For example, the action detection unit is capable of obtaining action information, with respect to the driver's action to turn up or turn down the volume, through a volume control means of a car audio unit.

### Favorite Analysis Section

The favorite analysis section 3 includes a favorite degree conversion unit 31 which calculates various detected data delivered from the favorite information detecting section 2, and converts to output signals representing driver's favorite degrees to enable the driver's favorite tendency to be judged on a quantitative basis, and a music table editing unit 33 which puts the calculated favorite degrees in conformity with music data. In the music table editing unit 33, each of music pieces is correlated with the driver's favorite degrees, with edited music selection table being transferred to and stored in the music table storage area 51.

### Music Title Selecting Section

As previously noted, it is possible for the favorite analysis section 3 to grasp the specific favorite tendency of the particular driver in response to the analyzed result of the favorite degrees. Since the favorite degrees are numerically expressed in the music selection table, it is possible to retrieve musical data and reorder it in another pattern. The music piece selecting section 4 includes a music editing unit 41 which enables editing by selecting (i.e., by retrieving and reordering) music pieces favored by the driver on the basis of the music selection table.

### Music Providing Section

Music edited by the music editing unit 41 in the music selecting section 4 is provided to the vehicle driver corresponding to the music selection command signal and by means of the music providing section 6. The music providing section 6 involves any one of widely available music reproducing devices such as a CD player, an MD player, an MO player and a cassette tape recorder, etc.

### Various Information

Now, various information will be described below in detail with reference to the drawings.

### Faborite Degrees

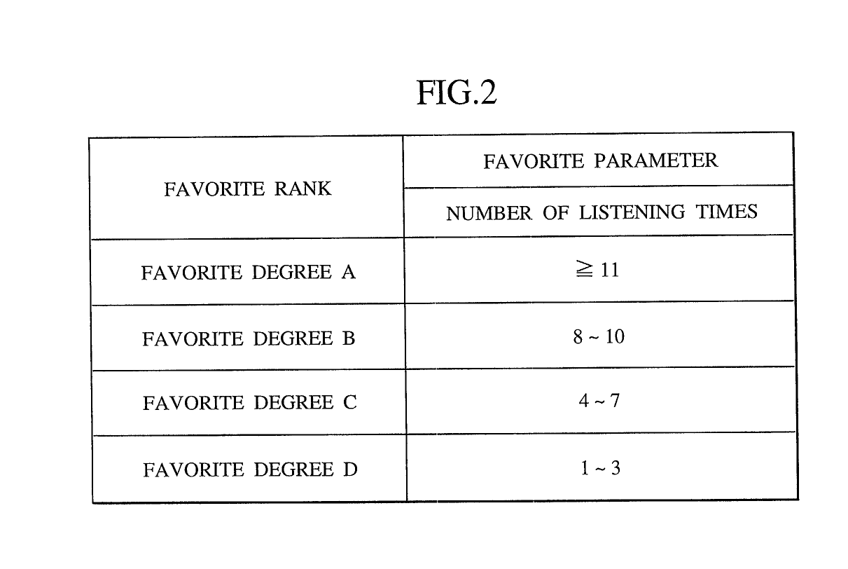

FIG. 2 shows a table for illustrating the relationship between a favorite rank and a favorite parameter. Row indicates the number of listening times for music. The favorite rank has favorite degrees graded in four stages that numerically represent the favorite tendencies of the driver, respectively. The numeric values indicative of the favorite tendency may be determined directly by the driver by giving marks to individual music pieces which he has listened, by a mark giving system wherein specified music pieces of a particular artist is applied with given marks, wherein the other specified music pieces that belong to a specific field are given with specific marks and wherein the music piece with a particular tempo is given with specific marks, or by another system associated with a hit chart. In such an embodiment, “the number of listening times” for a particular music piece is used to represent the favorite parameters indicative of the driver's favorite degrees. That is, as the “number of listening times” increases for the particular music piece increases, it appears that the particular music piece gains the driver's favorite, and it is possible for the particular music piece to be discriminated as the music piece that suits the driver's favorite in hid driving operation. In addition, the favorite parameter may be freely predefined in various patterns such as the number of repeated listening times per unit time (i.e., a frequency in listening music) or an order of listening music during his driving operation. More particularly, the favorite degree A is ranked when the number of listening times is equal to or above 11. The favorite degree B is ranked when the number of listening times remains in a value ranging from 8 to 10. The favorite degree C is ranked when the number of listening times remains in a value ranging from 4 to 7. The favorite degree D is ranked when the number of listening times remains in a value ranging from 1 to 3. The favorite rank may include any number of graded ranks, and the favorite rank may be composed of a layer structure. In this case, the layer structure may have not only one layer but also plural layers.

### Music Information and Vehicular Information

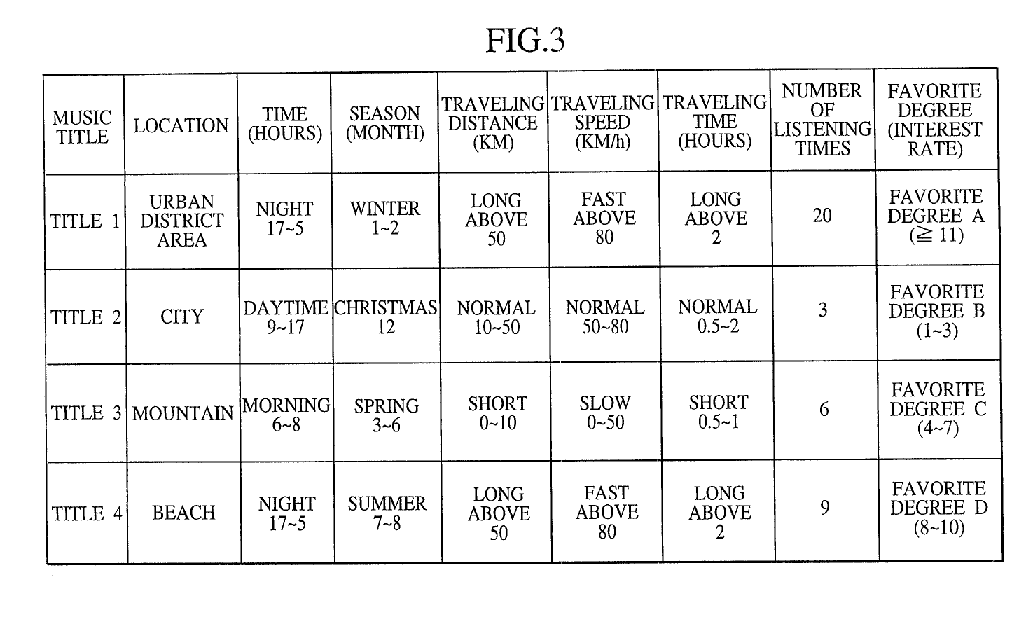

FIG. 3 shows a table for illustrating the relationship between music information and vehicle's information. The music information widely involves music-related information such as information indicative of selected music pieces and information indicative of contents of the music pieces, etc. Further, the music information widely involves other information such as information (i.e., ID information and information given for each vehicle's key) identifying the driver, information indicative of music itself, music titles, specific fields, artists, music instruments, musical players, a hit chart, record production companies, musical tempos, musical keys, musical rhythm patterns, time zones and seasonal zones, etc. In the illustrated embodiment, the music information is held in management in connection with the vehicle's information. Such a combination may involve not only the music information and the vehicle's information but also involve any one of or combination of plural information such as consciousness information and vehicle's traveling information.

More particularly, in FIG. 3, the uppermost line contains a MUSIC TITLE, a LOCATION, a TIME ZONE, a SEASONAL ZONES, a TRAVELLING DISTANCE RANGE, a TRAVELLING SPEED RANGE, a TRAVELLING TIME RANGE, the NUMBER OF LISTENING TIMES and a FAVORITE DEGREE (INTEREST DEGREE) that are assigned with each of music titles 1 to 4. The LOCATION column involves district area, city, mountain and beach. The TIME ZONE column contains night, daytime, morning and night. The SEASONAL ZONE column contains winter, Christmas holidays, spring and summer. The TRAVELLING DISTANCE RANGE contains a traveling distance expressed as “long”, “normal”, short” and “long”. The TRAVELLING SPEED RANGE column contains a traveling speed status expressed as “rapid”, “normal”, “slow” and “rapid”. The TRAVELLING TIME RANGE column contains a traveling time expressed as “long”, “normal”, “short” and “long”. The NUMBER OF LISTENING TIMES column contains the number of listening times the driver has performed. The FAVORITE DEGREE column contains the favorite degrees ranked in the four stages. Thus, each of music titlel 1 to 4 are correlated with music information and vehicular information in a manner discussed above. For example, the music title 1 is correlated with the LOCATION in urban district area, the TIME ZONE in night, the SEASONAL ZONE in winter, the TRAVELLING DISTANCE in “long”, the TRAVELLING SPPED RANGE in “long, the TRAVELLING TIME in “long”, and the NUMBER OF LISTENING TIMES in “20” times. With such information, it is possible for the status, for which the driver favors to listen to the particular music title 1, to be properly discriminated. Such information may be preliminarily recorded. It will thus be seen that from the above situation, the music title 1 is assigned with the favorite degree A and stored in the information storage section 5.

### Consciousness Information

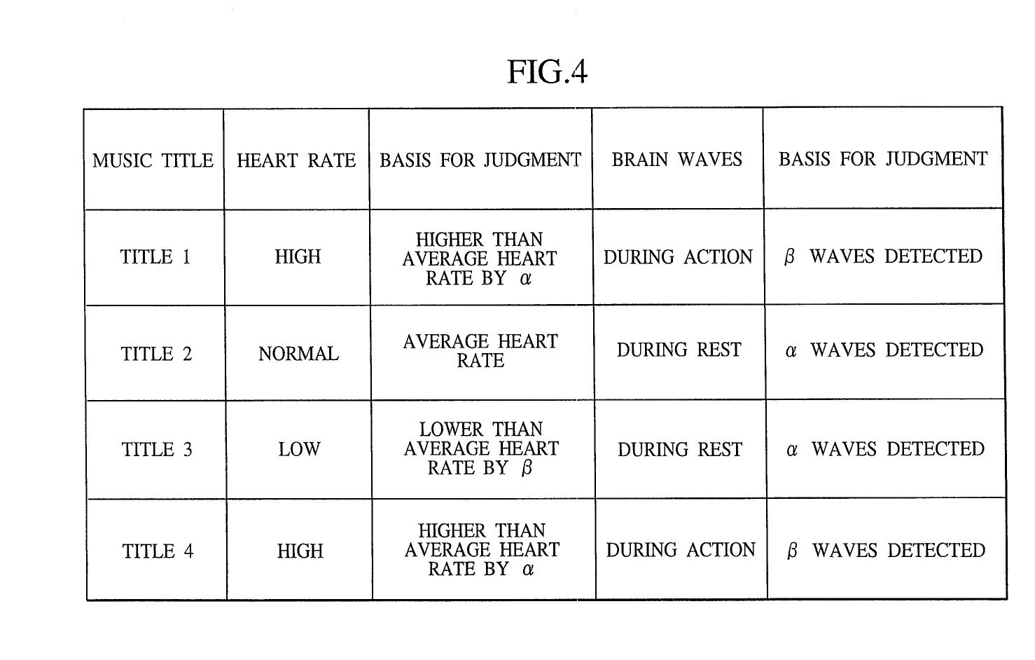

FIG. 4 shows a table illustrating the relationship between the music title and consciousness information. The consciousness information represents information indicative of a consciousness level of the driver when he has listened to the particular music piece. In such an embodiment, consciousness information is arranged to include the heart rate and brain waves. That is, where the driver listens to the particular music piece, the presence of the driver's heart rate remaining at a high or low level allows the consciousness level of the driver to be properly grasped. The terminologies “high level” or “low level” are determined based on a judgment basis wherein the heat rate is higher than the average heart rate by a value α and is lower than the average heart rate by a value β. The variation in such a heart rate allows the driver's consciousness level with respect to the particular music piece to be properly evaluated. Such an evaluation of consciousness is carried out on the basis of a table containing pre-generated resultant data values of the heart rates and the graded favorite degrees. Likewise, the evaluation of the brain waves is performed, in the same manner as that of the heart rates, with respect to whether the measured brain waves belong to the β wave that appears in active state of the driver or belong to the α wave that appears in rest state of the driver.

### Travelling Information of Vehicle

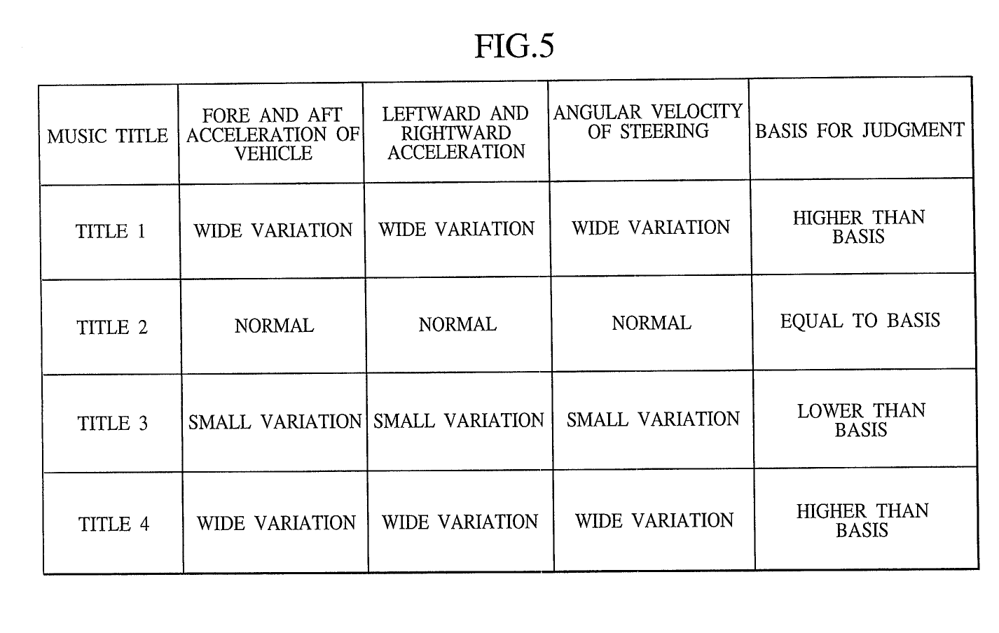

FIG. 5 shows a table for illustrating the relationship between the music title and the traveling information of the vehicle. The traveling information is indicative of measured information of variation in traveling conditions (i.e., fore and aft acceleration of the vehicle, leftward and rightward acceleration and the angular velocity of vehicular steering). Now, taking the uppermost line correlated to the music title 1 as an example, during driving the vehicle by the driver in a case where the music title 1 is turned on, it is clear that the fore and aft acceleration of the vehicle undergoes a wide variation, that the leftward and rightward acceleration undergoes a wide variation, that the angular velocity of the steering wheel undergoes a wide variation. With such a suggestion, it seems that the music title 1 provides a great possibility to cause the driver to roughly drive the vehicle. Although there may exist some cases where the driver's rough driving technique has no relation with the driver's favor with respect to the particular music piece, it is advisable for vehicle's information to be counted as a measure of the driver's original intention for achieving a safe driving, and thus, vehicle's information is calculated to obtain the graded driver's favorite degrees. Calculation of the favorite degrees on the basis of vehicular information is performed on the basis of the table wherein the traveling status (i.e., variations in traveling information) of the vehicle is preliminarily correlated with the driver's favorite during driving the vehicle.

### Driver's Will Information

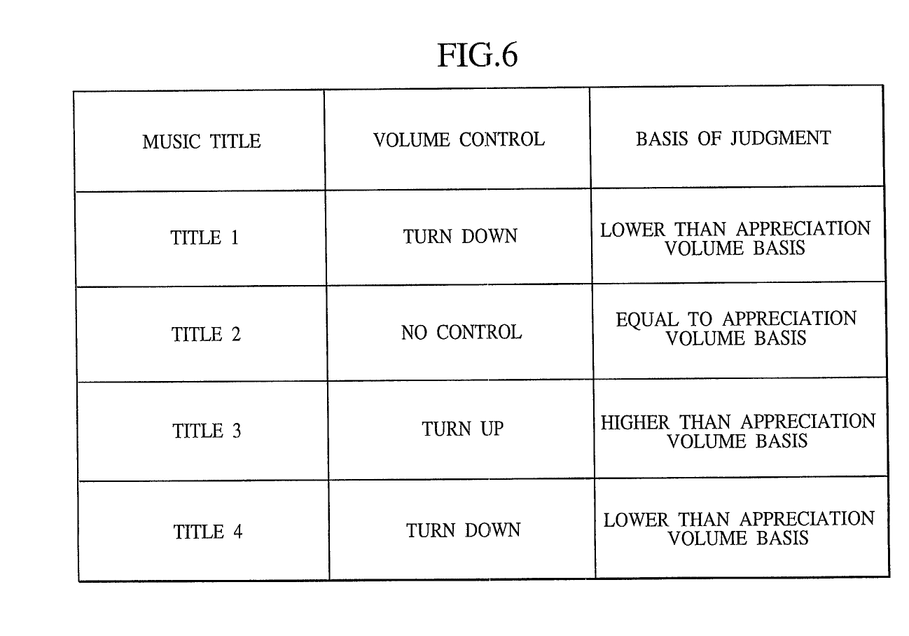

FIG. 6 shows a table for illustrating the relationship between the music title and driver's will information. The driver's will information refers to information indicative of the driver's favorite based on the driver's will to listen to the particular music piece. In such an embodiment, the driver's will is detected in terms of driver's action to turn up or turn down the volume. In particular, the driver's will detecting unit 24, shown in FIG. 1, detects an incremental displacement value of the volume turned by the driver. The detected resultant data of the incremental displacement value of the volume control is used for executing discrimination whether “the volume is turned down” in terms of a case where the volume is below or above an appreciation volume (i.e., the standard volume at which the driver listens to the particular music piece) as seen in the table FIG. 6. When the driver turns down the volume for the particular music piece, it is discriminated that the particular music piece is out of driver's favorite. On the other hand, when the driver turns up the volume for the particular music piece, it is discriminated that the particular music piece suits to the driver's favorite. The reason why driver's will information is obtained from a discrimination parameter composed of the appreciation volume instead of the volume control is based on the fact that if the mere volume control is used as the discriminating parameter for discriminating driver's will, there exists a case where the driver turns down the volume for conversation purposes or other purposes, and that a more reliable judgment is performed by taking consideration of the volume control in terms of the entire sound level in the passenger compartment to detect about whether the volume is turned up or the volume is turned down.

### Conversion Process

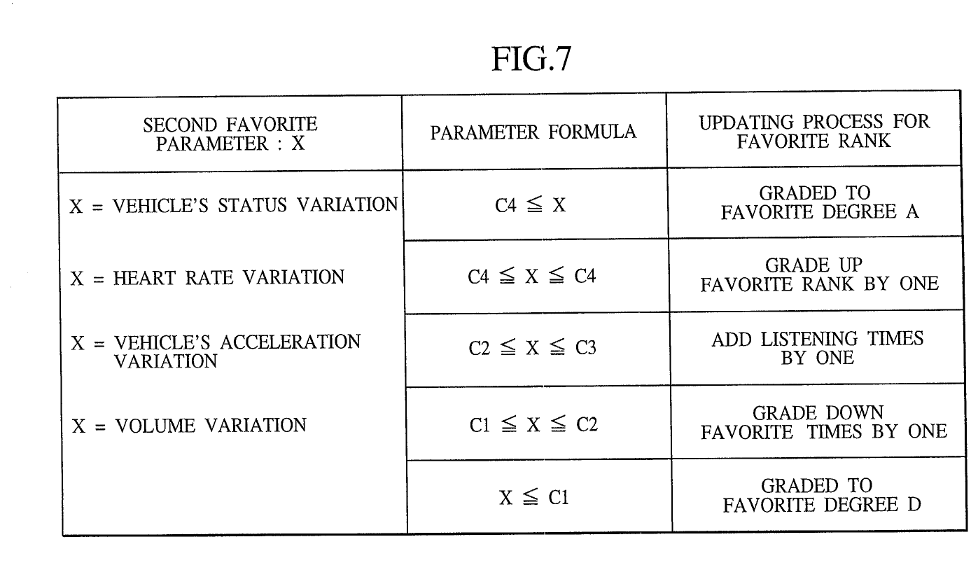

FIG. 7 shows a table for illustrating an example of a conversion process implemented by the favorite degree conversion unit 31 to describe how favorite information, detected by the vehicle status detection unit 21, the consciousness level detection unit 22, the traveling status detection unit 23 and the driver's will detection unit 24 of the favorite information detecting section 2, is converted and updated into the favorite degrees graded with a layer structure. In the first illustrated embodiment, data involving favorite information detected by the various detection units 21 to 24 and the number of listening times are used as a second favorite parameter representing the driver's favorite degrees. Here, the favorite degrees are evaluated with three layers including: (1) favorite rank, (2) the number of listening times and (3) variation in favorite information.

For example, assuming that the second favorite parameter is expressed as X=the variation in the heart rate, when the heart rate is greater than a given value C4, the favorite rank (i.e., in a first layer) is graded as A. In the case of C3≦X≦C4, the favorite rank (in the first layer) is graded up by one (i.e., the favorite rank C is updated to the favorite rank B). In case of C2≦X≦C3, the numeric value “1” is added to the number of listening times (i.e., the first favorite parameter in the second layer). By achieving this addition, the favorite rank (in the first layer) can be possibly shifted. In case of C1≦X≦C2, the favorite rank is ranked down by one (i.e., the favorite rank is updated from “C” to “D”). In case of X≦C1, the favorite rank is ranked down to the lowermost level “D”.

The second favorite parameter X may include all information that is obtained from favorite information, such as, except for the variation of the heart rate, the variation in the volume and the variation in the average traveling speed of the vehicle, etc. Also, the values in a range from C1 to C4 and the margin of each value are preset in compliance with the second favorite parameter X. Further, when determining the favorite degrees, alternation of the favorite parameter may be performed in a direct reflection to the favorite rank (i.e., in the first layer), or may be indirectly reflected to the first favorite parameter (i.e., the number of listening times: the second layer) and may be subsequently reflected to the favorite rank (i.e., in the first layer).

### Music Selection Table

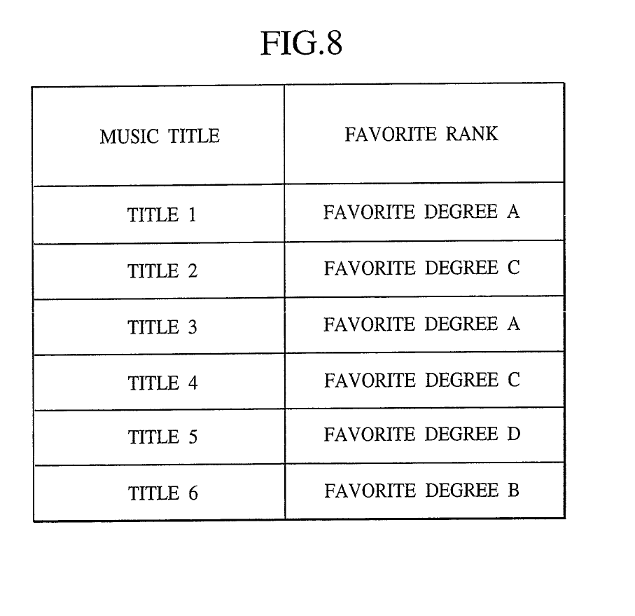

FIG. 8 is a view for illustrating a music selection table. The favorite degrees, which are obtained by the conversion process implemented by the favorite degree conversion unit 31 of the favorite analysis section 3 may be used as they are, or may be converted into the favorite ranks. The favorite degrees are indicative of the particular driver's favorite tendency and are stored in the music selection table in a correlated relationship with the respective music pieces. This information is newly prepared and, subsequently, is updated responding to collection of information and alternation of information. FIG. 8 illustrates an example of the music selection table. In such an example, the music pieces in titles 1 to 6 are correlated with the graded favorite degrees. In such a correlation, the music in title 1 has the greatest favorite degrees and is assigned with the favorite degree A, and the music piece in title 2 has a lower favorite degree C.

Thus, the music pieces in various titles, that are ranked, are selected and relocated to allow a music program to be edited in accordance with the favorite degrees of the driver who is in charge of driving the vehicle.

### Operational Overview

Now, the basic sequence of control in the first embodiment is described below to clarify how the aforementioned information is treated and processed in the audio system discussed above.

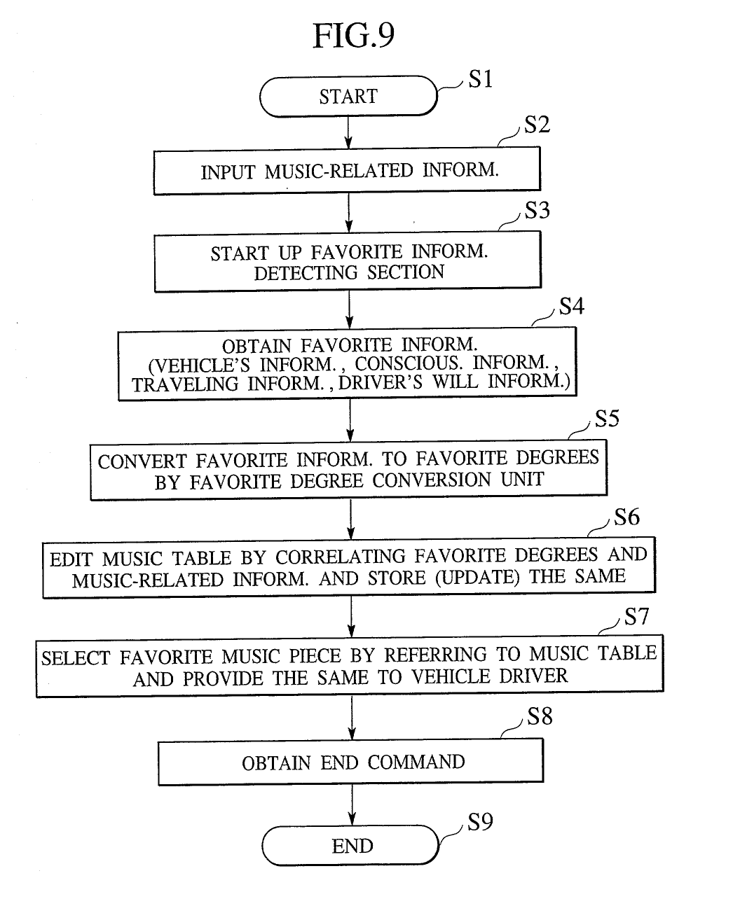

FIG. 9 is a general flow diagram for illustrating the basic sequence of operations which are executed by the audio system of the first embodiment. The audio system 10 operates in two modes: (1) a mode to execute analysis of the driver's favorite, and (2) a mode to provide the favorite music pieces, which are edited on the basis of the analyzed favorite, to the driver. At the start in step S1, i.e., when power is turned on, the operation of the audio system 10, which includes the favorite analysis section 3, is started up. In the next step S2, music information is applied to and stored in the input unit 1 to allow the favorite piece of music to be provided to the particular vehicle driver. Note should be taken here that the application of music information may be preliminarily carried out prior to the start up operation of the system and for the sake of explanation, such a process is exemplarily carried out in step S2 though not intended to limit the present invention to this particular case.

In the next step S3, the detection units 21 to 24 of the favorite information detecting section 2 are started up. Before start up, it is premised that a driver, whose favorite is to be analyzed, should be specified. In step S4, the detection units 21 to 24 obtain favorite information involving vehicle's status information, consciousness level information, vehicular traveling status information and will information, respectively. In step S5, the favorite degree conversion unit 31 of the favorite analysis section 3 converts the favorite information into a plurality of the graded favorite degrees. In the execution of step S6, the music table editing unit 33 functions to edit the music selection table in compliance with information involving the favorite degrees and the music pieces and delivers the edited resultant music data to the music data storage area 52 of the information storage section 5 to store the same, which is suitably updated.

In the next step S7, the music editing section 41 of the music selecting section 4 selects the favorite music pieces from the music selection table and correspondingly the music providing section 6 provides the selected music pieces to the driver. Upon receipt of the end command signal in step S8, the music providing service is completed in a step S9.

According to the first embodiment, the favorite tendency of the driver who is driving the vehicle is detected through the driver's favorite information and by executing the analysis of the driver's favorite information, which in turn is converted to the “favorite degrees”, enabling an ideological favorite tendency of the driver with respect to the particular music piece to be treated in a quantificational manner. The favorite degrees are correlated with information related to the music pieces and are put in order (i.e., edited for the music selection table), allowing the music piece, that is matched to the driver's favorite, to be selected, edited and provided to the driver under his driving operation, thereby enabling a comfortable driving environment to be realized for the vehicle driver.

More specifically, the favorite degree conversion unit functions to convert the favorite information, detected by the favorite information detecting section, into the favorite degrees indicative of the favorite tendency of the driver. With such conversion, it becomes possible for the resultant data (i.e., resultant measured data, resultant numerical values or other information, which are variable when the driver happens to listen to the music, such as vehicle's status information, consciousness level information peculiar to the vehicle driver, traveling status information and driver's will etc.) to be converted to information indicative of the driver's favorite with respect to the music piece. The converted information is then quantified to enable a quantificational analysis of the driver's favorite with respect to the music piece. The resultant analyzed data is correlated with the music-relation information as the favorite degrees.

The music table editing unit executes such a correlation process for the favorite degrees and the music related information to prepare the music selection table, which is then stored in the information storage section. Here, the word “storing” also includes the meaning of “updating the preliminarily stored music selection table”.

Upon receiving the music selection command from the driver, the music selecting section selects the favorite music pieces with reference to the music selection table and executes editing for the music selection table with a combination of these favorite music pieces or reordering these favorite music pieces. Upon completion of editing the music selection table, the favorite music pieces are provided to the vehicle driver through the music providing section. Here, the word “music piece selection” and “editing the music pieces” involve the meanings: that the music pieces are reordered or reallocated in order of the height of the favorite degrees; that the music pieces are selected in dependence on the driving status (i.e., when the traveling distance is long, when the vehicle is heading for the beach, when the driver drives the vehicle in the night, and when the driver drives the vehicle in the rain, etc.) to suit the currently driving status; and that the music pieces are reallocated in terms of various information, as key factors, contained in the music-related information.

Thus, the favorite tendency of the vehicle driver with respect to the particular music piece is detected through the favorite information, which is then converted to the “favorite degrees” for thereby allowing the favorite tendency, which is ideological, to be treated in a quantified manner. With such conversion, the favorite degrees are correlated with the music-related information and put in order (i.e., editing the music selection table), thereby allowing the favorite music pieces to be selected from and edited in the music selection table during driving of the vehicle to be provided to the vehicle driver.

In accordance with one feature of the present embodiment, the favorite information is composed of vehicle's information which is related with a vehicle's status.

More specifically, the vehicle's information includes various information related to the vehicle's status and may widely involve various situations such as a vehicle's location, the current date and hours, time, traveling time, traveling speed and climates, etc. Such information may be inputted by the driver himself through the input section or may be obtained from and input to the information storage section through a car navigation system.

Thus, it will thus be seen that according to the present embodiment, it is possible for the audio system to grasp the driver's favorite responding to the vehicle's status. That is, it becomes possible for the audio system to select the favorite music pieces especially preferred in driving the vehicle directed to the beach or the favorite music pieces especially preferred when the vehicle is traveling at a high speed.

Alternately in the present embodiment, the favorite information includes consciousness information related to a driver's consciousness level.

More specifically, the consciousness level includes information, based on which the driver's consciousness at the time of driving the vehicle can be analyzed. This information may widely include the driver's heart rate and brain waves, etc. Such information may be inputted through the input section from sensors (i.e., the favorite detecting section) located so as to detect information from the body of the driver. For example, the audio system may include a sensor whose terminals are adapted to be attached to the driver's ear.

Thus with such an arrangement, as to the music pieces to which the driver listens during driving the vehicle, it is possible for the audio system not only to catch the driver's physiological change that the driver can not be conscious of, and to catch the driver's subjective likes and dislikes with respect to the music pieces, but also to grasp the driver's favorite with respect to the music pieces, in terms of whether or not the favorite music pieces contribute to a driver's comfortable driving touch.

Alternately in the present embodiment, the favorite information includes traveling information related to the traveling condition of the vehicle.

More specifically, the raveling information include information, based on which it is possible to analyze the traveling condition of the vehicle such as fore and aft acceleration of the vehicle, leftward and rightward acceleration of the vehicle and an angular velocity of steering angle of a steering wheel, etc. With such information, in the event that a big difference appears in the fore and aft acceleration, the leftward and rightward acceleration and the angular velocity of the steering angle before and after the vehicle driver happens to listens to the particular music piece, then it is discriminated that the driver's driving technique became rough owing to his listening to that particular music piece.

Thus with such an arrangement, it is possible for the audio system to utilize the traveling information to analyze the music pieces whether or not these factors adversely affect the driver's driving technique (i.e., rough driving or careful driving), enabling the favorite music pieces to be selected and provided to the driver to be suited for the driver's careful (i.e., safety) driving touch.

Alternately in the present embodiment, the favorite information includes driver's will information.

More specifically, the driver's will information includes information which represents the driver's subjective favorite kept by the driver with respect to the music pieces during driving operation. When the music piece, which is running on during the driving operation of the vehicle, gains the driver's favorite, the driver may turn up the volume. On the contrary, if the music piece does not gain the driver's favorite, the driver may turn down the volume or may skip the volume.

Thus, it will thus be understood that according to the present invention, it is possible to grasp the driver's subjective favorite tendency, based on the driver's action relative to the music pieces which the driver listens to during the driving operation, without the need for specific input operation.

### Second Embodiment

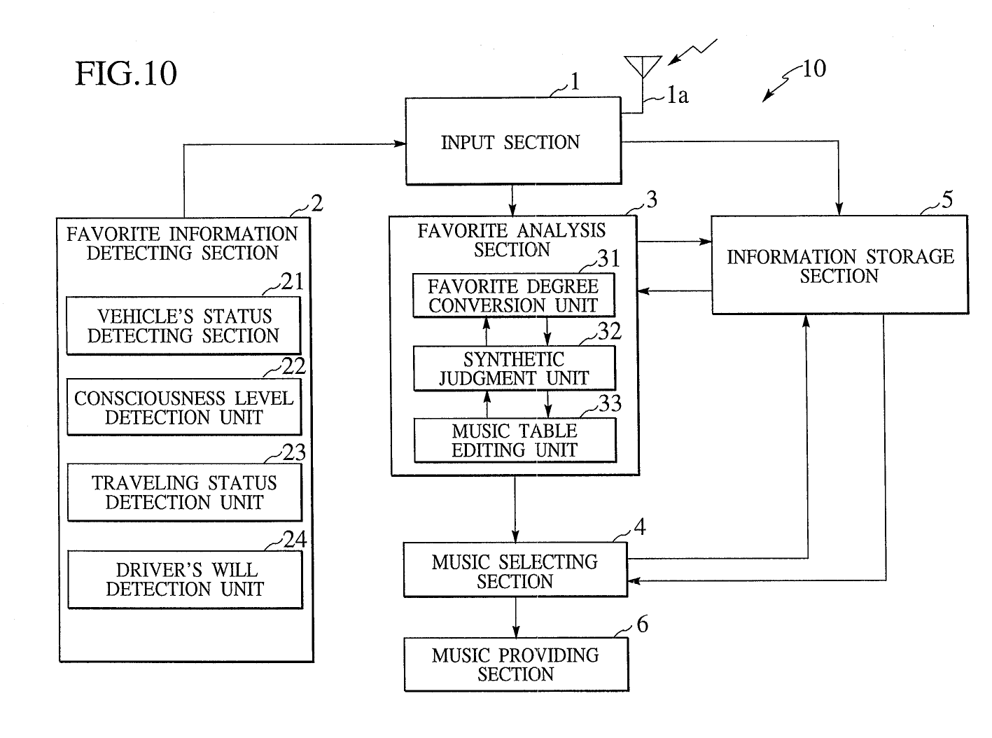

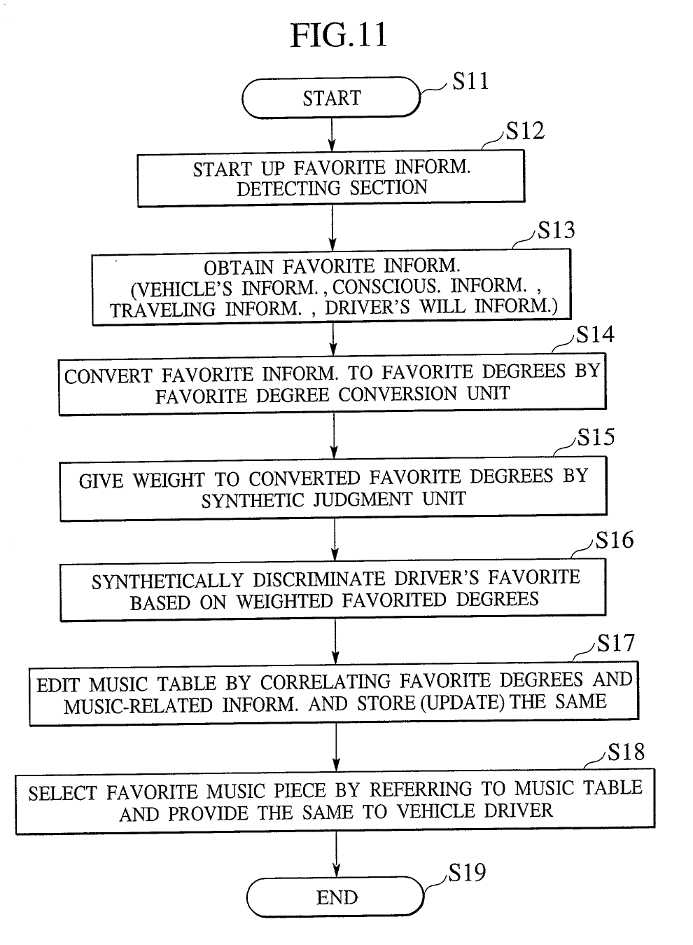

FIG. 10 shows a block diagram of an audio system of a second embodiment according to the present invention, with like parts bearing the same reference numerals as those used in FIG. 1 and a detailed description of the same parts being omitted for the sake of simplicity. FIG. 11 shows a general flow diagram of the basic sequence of operations of the audio system shown in FIG. 10.

In the second embodiment, the audio system 10 basically operates in the same manner as the audio system of the first embodiment shown in FIG. 1, and a detailed explanation will be given only to parts different in structure from the first embodiment.

In the second embodiment, the favorite information detecting section 2 detects vehicle's status information, conscious level information, traveling status information and driver's will information in the same manner as in the first embodiment. In the first embodiment, the favorite analysis section 3 discriminates the driver's favorite tendency on the basis of either one of the above favorite information. On the contrary, in the second embodiment, the favorite analysis section 3 includes a synthetic judgment unit 32 which synthetically discriminates the driver's favorite tendency by taking a combination of the aforementioned favorite information, such as vehicle's status information, consciousness level information, vehicular traveling status information and driver's will information, into consideration.

Although it is possible for the synthetic judgment unit 32 to discriminate the driver's favorite tendency with a process wherein the favorite degrees calculated by the favorite conversion unit 31 are simply summed, the synthetic judgment unit 32 of the second embodiment functions first to give weights to favorite information inclusive of vehicle's status information, consciousness level information, traveling status information and driver's will information which are calculated to synthetically discriminate the driver's favorite tendency.

For example, since the driver's will information tends to be based on the driver's will such as likes and dislikes, objectively grasping the driver's will, which effects on the driving property responding to the particular music piece, renders the favorite tendency to be relatively inaccurately discriminated. Therefore, by giving weights to consciousness information rather than by using driver's will information, it is possible for the favorite tendency of the driver, under his driving status, to be synthetically discriminated in a more accurate manner. The extent of weight to be given to the consciousness information may freely have arbitrary values, and heavy weights may be given to not only the objective consciousness information and traveling status information but also to subjective driver's will information.

In the second embodiment, the synthetic judgment of the favorite tendency is typically carried out in a process expressed by a formula:

Synthetic Favorite Degree=(favorite degree 1×α₁+favorite degree 3×α₂)/(α₁+α₂)

wherein α₁ and α₂ are determined to arbitrary values. The favorite degrees may be in the form of the favorite rank or in the form of the favorite parameter.

The basic sequence of control is described below with respect to the operation of the synthetic judgment unit 32 with reference to FIG. 11. At the start in step S11, power is applied to the audio system 10. In the next step S12, the plural favorite information detection units 21 to 24 are started up. In the execution of step S13, vehicle's status information, consciousness level information, traveling status information and driver's will information are obtained. In step S14, the favorite degree conversion unit 31 converts the detected resultant values into graded favorite degrees.

In step S15, the synthetic judgment unit 32 of the favorite analysis section 3 functions to give weights to the converted, resultant favorite degree data. In step S16, the synthetic judgment unit 32 further processes to execute discrimination of the driver's favorite in the synthetic manner on the basis of the weighted favorite degrees.

In step S17, the music table editing unit 33 edits the music selection table by correlating the favorite and the music piece with one another, stores the music selection table and suitably updates the data in the music selection table. As such, the synthetic judgment involving the weighted data is reflected on the music selection table. In step S18, the music selecting section 4 selects the favorite music piece that gains the driver's favorite, from the music selection table, with the selected music piece being provided by the music providing unit 6 in step S6. Upon receiving the end command, the operation of the system is completed in step S19.

In the second embodiment, it is possible for the favorite analysis section 3 to synthetically discriminate the driver's favorite tendency in more accurate manner as compared to the case wherein the driver's favorite is discriminated in view of one of vehicle's status information, conscious level information, traveling status information and driver's will information. Further, since the converted favorite degrees are given with weights, it is possible to discriminate the driver's favorite on the basis of either one of respective information parameters as a central factor with the remaining information parameters used as an auxiliary factor, enabling the analysis of various favorites to be multilaterally implemented in dependence on the driver's status and the vehicle's status, etc.

The entire content of a Patent Application No. TOKUGAN 2000-309242 with a filing date of Oct. 10, 2000 in Japan is hereby incorporated by reference.

Although the invention has been described above by reference to certain embodiments of the invention, the invention is not limited to the embodiments described above. Modifications and variations of the embodiments described above will occur to those skilled in the art, in light of the teachings. The scope of the invention is defined with reference to the following claims.

What is claimed is:

1. An audio system providing a favorite piece of music to a vehicle driver during a driving operation of the vehicle driver, comprising:
an input section to which music-related information is inputted;
an information storage section storing the music-related information inputted to the input section;
a favorite information detecting section detecting favorite information to discriminate favorite tendency of the vehicle driver with respect to the favorite piece of music;
a favorite analysis section analyzing a favorite of the vehicle driver on the basis of the detected favorite information and transferring analyzed resultant data to the information storage section to be stored thereby;
a music selecting section selecting the favorite music piece on the basis of the analyzed resultant data; and
a music providing section providing the selected favorite music piece to the vehicle driver.

2. An audio system according to claim 1, wherein the favorite analysis section includes:
a favorite degree conversion unit converting the favorite information into favorite degrees representing the favorite tendency of the vehicle driver; and
a music selection table editing unit editing a music selection table so as to allow the favorite degrees, converted by the favorite conversion unit, to be correlated with the music related information and transferring the music selection table to the information storage section to be stored thereby,
and wherein the music selecting section includes a music editing unit selecting and editing the favorite music piece with reference to the music selection.

3. An audio system according to claim 1, wherein the favorite information is vehicle information related to a status of the vehicle.

4. An audio system according to claim 1, wherein the favorite information is consciousness information related to consciousness level of the vehicle driver.

5. An audio system according to claim 1, wherein the favorite information is traveling information related to a traveling status of the vehicle.

6. An audio system according to claim 1, wherein the favorite information is driver's will information related to will of the vehicle driver.

7. An audio system according to claim 1, wherein the favorite information includes at least two of vehicle information related to a status of vehicle, consciousness information related to consciousness level of the vehicle driver, traveling information related to a traveling status of the vehicle, and driver's will information related to will of the vehicle driver,
and wherein the favorite analysis section includes a favorite degree conversion unit converting the favorite information into favorite degrees representing the favorite tendency of the vehicle driver and a synthetic judgment unit giving weight to the favorite degrees, converted by the favorite degree conversion unit, and synthetically discriminating the favorite of the vehicle driver on the basis of the weighted favorite degrees.

8. An audio system providing a favorite piece of music to a vehicle driver during a driving operation of the vehicle driver, comprising:
inputting means for inputting music-related information;
information storing means for storing the music-related information;
favorite information detecting means for detecting favorite information to discriminate favorite tendency of the vehicle driver with respect to the favorite piece of music;
favorite analyzing means for analyzing a favorite of the vehicle driver on the basis of the detected favorite information and transferring analyzed resultant data to the information storage means to be stored thereby;
music selecting means for selecting the favorite music piece on the basis of the analyzed resultant data; and
music providing means for providing the selected favorite music piece to the vehicle driver.

9. A method of providing a favorite piece of music to a vehicle driver during a driving operation of the vehicle driver, comprising:
detecting favorite information to discriminate favorite tendency of the vehicle driver with respect to the favorite piece of music;
analyzing driver's favorite on the basis of the detected favorite information and storing analyzed resultant data;
selecting the favorite music piece on the basis of the analyzed resultant data; and
providing the selected favorite music piece to the vehicle driver.
